(19) United States
(12) Patent Application Publication
(10) Pub. No.: US 2006/0007779 A1
(43) Pub. Date: Jan. 12, 2006

(54) Blender

(75) Inventors: Juan Fernandez, Towaco, NJ (US); Paul McGrath, Towaco, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Products of Tomorrow, Inc., Towaco, NJ (US)

(21) Appl. No.: 10/885,274

(22) Filed: Jul. 6, 2004

(51) Int. Cl. B01F 7/00; B01F 13/00

(52) U.S. Cl. 366/206; 366/205; 366/601

(57) ABSTRACT

A blender is disclosed. The blender includes a blender body, an electronic circuit, a container, a blade base, and a cap. The electronic circuit shuts down a motor located in the blender body upon the lapse of a time period.

### FIELD OF THE INVENTION

The present invention relates to kitchen appliances, and more particularly to blenders and other food processing devices.

### BACKGROUND OF THE INVENTION

The household blender is a useful tool for preparing a variety of mixtures. Blenders known in the prior art provide a single tool for mixing, chopping, mincing, cutting, slicing, etc. . . . various liquids or other materials. Whether preparing a drink or mincing some ingredients for an entrée, the typical blender is a simple to use kitchen device. As such, it is an extremely popular tool for bartenders and cooks of all skill levels and positions.

The average blender includes a blender base or body that can be coupled with a blending container. The blender body usually includes a motor and a drive assembly for connection to a blade located in the blending container. The motor and drive assembly, when actuated, rotate the blade, and variations in the speed of the rotation determines the amount of blending of the materials placed in the container. Many higher end blending devices also include automated controls for varying the operation of the blender (i.e.—varying the speed of rotation of the motor and drive assembly).

While this typical design provides a worthy and useful kitchen device, it is not without its drawbacks. For example, standard blenders often fail to completely blend/mix materials located within their containers or take a significant period of time to do so. Additionally, standard blenders are dimensioned for blending larger quantities of materials, rather than convenient smaller single serving quantities. As such, standard kitchen blenders also do not typically offer small easily interchangeable containers that can be used as serving cups. Therefore, there exists a need for an improved blender that provides quick blending capabilities for convenient quantities.

To meet this need, there have been several attempts at improved blenders. For example, one such blender is shown in U.S. Design Pat. No. D487,668 (“the '668 patent”). Blenders of this type are generally smaller than the average kitchen blender and include a blender body, a blade base, and individual serving containers. Operation of a blender, like that shown in the figures of the '668 patent, requires that the individual serving containers are first loaded with materials. Thereafter, a blade base is attached to the container and the combination is inverted prior to being placed on the blender base. Blending of the materials is done by turning on a motor located in the blender body, which is coupled to a blade in the blade base by a drive shaft. The rotation of the motor and drive shaft, and hence the blade both blends the materials, and forces the same around the curvature of the container. Upon completion of satisfactory blending of the materials, the container and blade base combination is removed and inverted, and the blade base is removed, thereby providing a single serving container housing the blended materials. The container can be used as a drinking cup for consuming the mixture blended therein.

One drawback with blenders of the type shown in the '668 patent, is the propensity of the motor to overheat during operation. This problem may be exacerbated from the desire for the smaller size of the blender body and the desire to use more powerful motors for quicker operation. This problem of heat can become a safety concern, as build up of heat due to long running times can become a fire hazard. For this reason, blenders are tested against safety standards set by groups like Underwriters Laboratory Inc., of Northbrook, Ill. (“UL”). The tests for certifying a product to meet these safety standards place the device under rigorous operating conditions to ensure that the product is safe for use by a consumer. For example, on test subjects the blender to extended use, while at the same time monitoring its temperature. Given the trend for smaller, more powerful devices, there exists a need for a blender design that is capable of safely dispersing heat from the blender body.

### SUMMARY OF THE INVENTION

According to a first embodiment of the present invention, a blender is provided that comprises a blender body including a motor coupled to a drive shaft; an electronic circuit providing for shut down of the motor after predetermined time to prevent overheating of the motor; a container having an interior and one open end; a blade base including at least one blade, a first end of said blade base adapted to be coupled to the drive shaft, and a second end of said blade base adapted to be attached to the open end of said container, wherein rotation of the drive shaft causes rotation of the at least one blade and wherein attachment of said blade base substantially seals the interior of said container; and a cap adapted to be attached to the open end of said container.

According to another embodiment of the present invention, a blender is provided that comprises a blender body including a motor coupled to a drive shaft; a container having an interior and one open end; a blade base including at least one serrated blade, a first end of said blade base adapted to be coupled to the drive shaft, and a second end of said blade base adapted to be attached to the open end of said container, wherein rotation of the drive shaft causes rotation of the at least one blade and attachment of said blade base substantially seals the interior of said container; and a cap adapted to be attached to the open end of said container.

According to another aspect of the present invention, a method of blending a mixture is provided that comprises providing a blender including a container, blade base, and blender body; placing ingredients in a container; attaching a blade base to the container; inverting the blade base and container; placing the blade base on a blender body; operating the blender body to mix the ingredients in the container; removing the blade base and container from the blender body; inverting the blade base and container; and removing the blade base from the container, wherein the step of operating the blender body to mix the ingredients in the container includes operating a motor, the motor designed to shut down after a period of time to prevent overheating of the motor.

### BRIEF DESCRIPTION OF THE DRAWINGS

A more complete appreciation of the subject matter of the present invention and the various advantages thereof can be realized by reference to the following detailed description in which reference is made to the accompanying drawings in which:

FIG. 1 is a side perspective view of the blender according to an embodiment of the present invention;

FIG. 2 is a side perspective view of the container and blade base separated from one another according to FIG. 1;

FIG. 3 is a block diagram of the control components of the blender body according to FIG. 1;

FIG. 4 is a side perspective view of the blender according to the embodiment shown in FIG. 1 with various elements;

FIG. 5 is a perspective view of the drinking rim used in conjunction with the blender of FIG. 1;

FIG. 6 is a circuit diagram of the blender;

FIG. 7 is a bottom perspective view of the blender showing vents on the side and bottom of the blender body;

FIG. 8 is a top plan view of the blade assembly of the blade base according to the embodiment shown in FIG. 1;

FIG. 9 is a side perspective view of the blender according to another embodiment of the present invention; and,

FIG. 10 is a side perspective view of the blender according to another embodiment of the present invention.

### DETAILED DESCRIPTION

In describing the preferred embodiments of the subject matter illustrated and to be described with respect to the drawings, specific terminology will be used for the sake of clarity. However, the invention is not intended to be limited to any specific terms used herein, and it is to be understood that each specific term includes all technical equivalents which operate in a similar manner to accomplish a similar purpose.

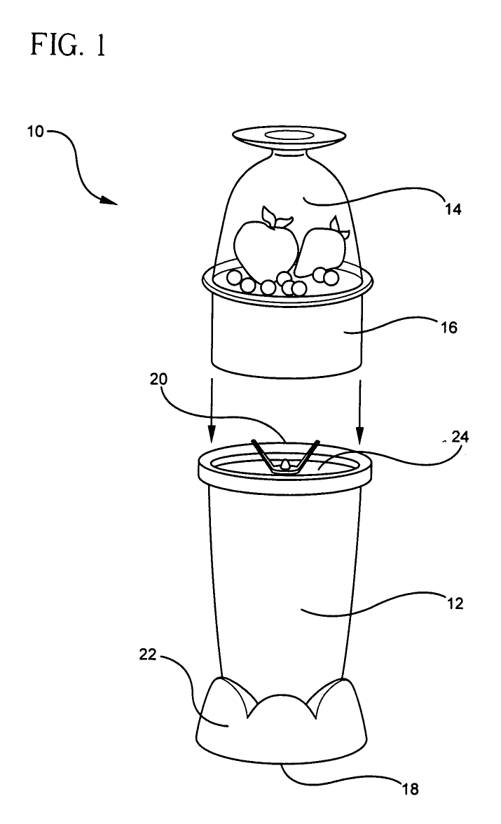

Referring to the drawings, wherein like reference numerals represent like elements, there is shown in the Figures, in accordance with embodiments of the present invention, a blender designated generally by reference numeral 10. As best shown in FIG. 1, blender 10 includes a blender body 12, a container 14 adapted to receive and retain the material to be blended, and a blade base 16 which is removably connectable to the container 14. In the preferred embodiment shown the Figures, blender 10 is designed to be used in blending together liquids or food ingredients. However, it should be noted that blender 10 can be utilized to blend other materials.

Blender body 12 is preferably a cylindrical body having a shape similar to that of a bullet. This “bullet-shaped” body provides a suitable housing for the inner components of the blender, while also providing a structure that is easy to grasp and manipulate. Blender body 12 has a lower end 18 and an upper end 20 and further includes a body base 22 located on lower end 18 and an opening 24 located on upper end 20. Body base 22 supports body 12 and allows for blender 10 to stand upright. Opening 24 provides an interface for coupling with container 14, which will be discussed further below.

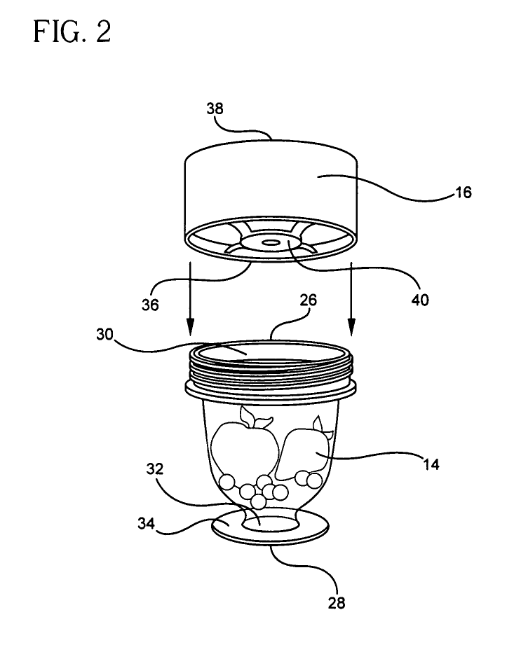

As best shown in FIG. 2, the preferred container 14 is a curved cylindrical cup having a first end 26 and a second end 28. The curvature and cylindrical nature of container 14 allows for an enhanced blending of material to take place therein. In operation, the design of container 14 causes any material blended within it to be circulated throughout, thus providing more blending than the average (non-curved) blender. Container 14 further includes a threaded opening 30 located at first end 26 and a stem 32 and a rest 34 located at second end 28. Threaded opening 30 is the opening through which materials are inserted into container 14, and its threaded nature provides means for coupling with blade base 16. Stem 32 is essentially an elongate member connecting the main body of container 14 with rest 34. This combination allows for container 14 to be rested on a surface. It is contemplated that other means for allowing container 14 to stand upright are contemplated.

Blade base 16 is a cylindrical body having a blade end 36 and a coupling end 38, and further includes a blade assembly 40 located at blade end 36 and a coupling 42 (not shown in FIG. 2) located at coupling end 38. Blade base 16 is adapted to couple with container 14 through the cooperation of threaded opening 30 and blade end 36. While both sections in the preferred embodiment are threaded, it is contemplated that other types of connections can be utilized. For example, threaded opening 30 and blade end 36 can be adapted to couple together by snapping blade base 16 onto container 14. It should be noted that, upon the coupling of container 14 and blade base 16, threaded opening 30 of container 14 is sealed. Therefore, any material located therein is prevented from escaping therefrom. Coupling 42 is connected to blade assembly 40, so that rotation of coupling 42 also provides rotation to blade assembly 40. Coupling 42 is utilized in engaging with a drive shaft, as will be discussed further below.

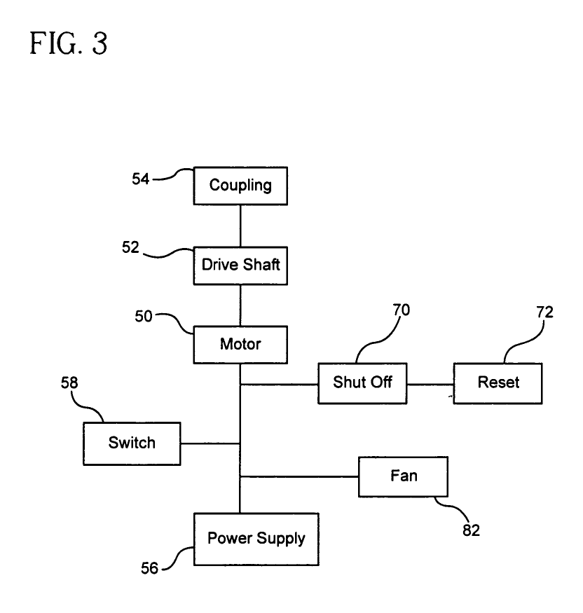

Blender body 12 also houses a motor 50, a drive shaft 52, and a coupling 54, as depicted in FIG. 3. While the embodiments shown include a motor of overly sufficient power (to quickly blend materials), it is contemplated that any motor can be utilized. Motor 50 is engaged with shaft 52 so that motor 50 causes rotation of shaft 52. Shaft 52 is connected with coupling 54, thus causing rotation of coupling 54. A power supply 56 is also provided for powering motor 50. In certain embodiments, power supply 56 is a plug and cord for use with a standard wall socket. However, it is contemplated that motor 50 can be powered by several different types of power supplies. For example, power supply 56 can be a lithium or other rechargeable battery. Additionally, standard batteries such as AA or AAA batteries can be utilized. Finally, blender 10 may include a switch 58 for selectively providing power to motor 50. In the preferred embodiment shown in FIG. 1, the switch is located within threaded opening 20, and is actuated by forcing container 14 towards blender base 12 (i.e.—pushing down on container 14). However, it is contemplated that other switches can be used, for example, standard on-off switch as are known to those of ordinary skill in the art.

In operation, blade base 16 is screwed onto container 14, after materials are placed therein (best shown in FIG. 1). The combination of container 14 and blade base 16 is then inverted and placed onto blender body 12 so that coupling 42 of blade base 16 mates with coupling 54 of blender body 12. Coupling 54 is adapted to engage with coupling 42 of blade base 16. Upon power being supplied to motor 50, drive shaft 52 and coupling 54 rotate, thereby causing rotation of coupling 42 and blade assembly 40. Thereafter, blade assembly 40 blends the materials located within container 14. As discussed above, the materials are caused to circulate around container 14, and more evenly blend. Subsequent to achieving desired blending and shutting down motor 50, container 14 and blade base 16 are simultaneously removed from blender body 12. Blade base 16 is then unscrewed from container 14 and the materials located within container 14 can be accessed. It is contemplated that container 14 can be used as an individual serving or drinking cup, or materials blended therein can be removed therefrom.

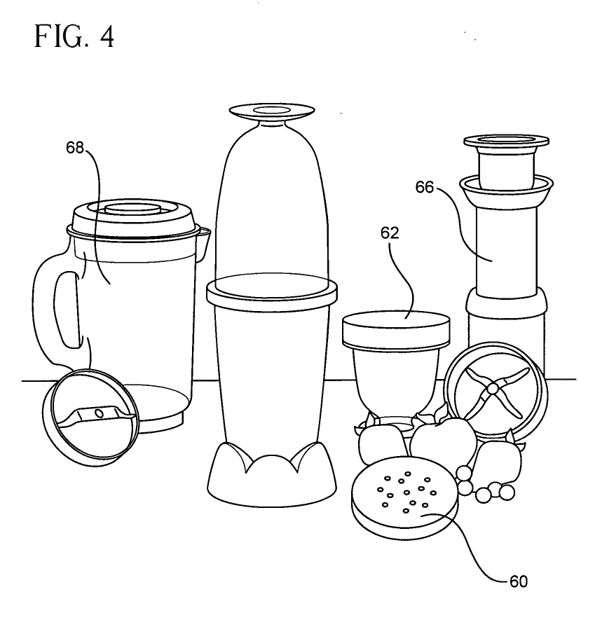

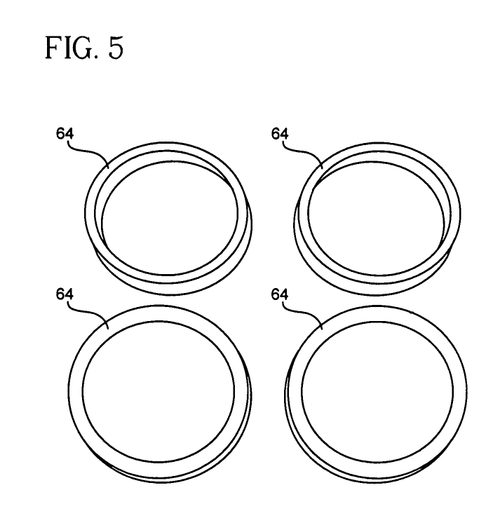

It is contemplated that container 14 can be used in conjunction with other caps/lids. For example, as shown in FIG. 4, a shaker top 60, a storage lid 62, and a drinking rim 64 (shown in FIG. 5) is provided. Shaker top 60 is a cap with a plurality of holes useful for dispelling grated cheese and the like from container 14. Storage lid 62 is a cap that substantially seals container 14 useful for storing used materials in a refrigerator. Both of these caps engage threaded opening 20 so as to remain fixed to container 14. Drinking rim 64 also engages threaded opening 20, so as to cover the threads. Drinking rim 64 is useful for drinking directly from container 14. It is also contemplated that blender base 12 can be used with other attachments than the standard containers 14. For example, as is also shown in FIG. 4, it is contemplated to use blender base 12 with a juicer attachment 66 or a standard blender pitcher 68. However, there exist other possibilities of attachments.

As mentioned above, one problem with blenders similar to that of the present invention is the propensity of motor 50 to overheat. The need for quick blending capabilities directly creates the need for a higher than average powered motor 50. Clearly, placing a high powered motor in a small housing like that of blender body 12, will cause a heat concern, the main concern being that extended operation of blender 10 could actually create a fire. The aforementioned tests done by groups like UL typically attempt to prevent products that may produce excessive heat from becoming available without certain safety measures. Generally, the safety tests performed on such devices monitor the heat level generated by blender 10 during a specific time period of operation. If the temperature of any of the components of blender 10 exceeds a certain temperature, the product will fail and not be safety certified. The present invention provides several additions aimed at preventing excess heat from building up and becoming a fire hazard, while still allowing for sufficient short term use of blender 10.

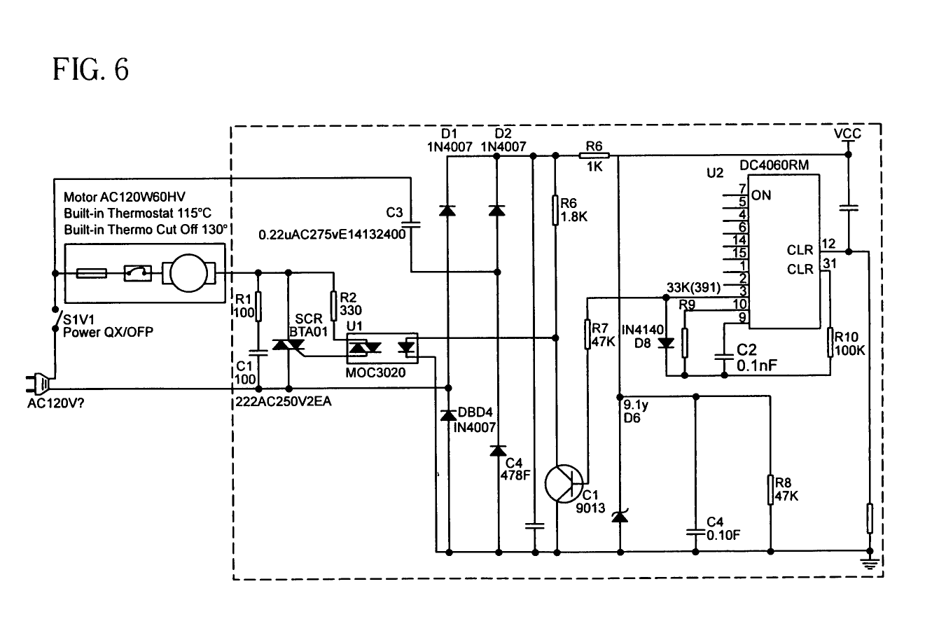

In certain embodiments of the present invention, depicted in FIG. 3, blender 10 further includes a timer or other shut off mechanism 70 for preventing overheating of motor 50. Essentially, shut off 70 prevents blender 10 from operating after a certain period of time elapses. This, in turn, prevents heat from building up due to excessive operation (the most common reason for heat build up). A preferred time period, after which motor 50 is shut off, is about thirty (30) seconds. However, it is clear that other appropriate times can be set as the shut off time period to balance a need for short term use and heat build up. For example, it is envisioned that the time period can be any amount within the range of one (1) second to one hundred eighty (180) seconds. An embodiment of a circuit design is shown in FIG. 6, however, others are envisioned. As is shown in the Figure, after operating for thirty (30) seconds, blender 10 will shut off and cease to operate. It is contemplated that blender 10 may also include a reset 72 for allowing the operation of blender 10 after the shut off time period is met. Reset 72 in essence resets shut off 70, to allow for another thirty (30) seconds of operation time. Reset 72 is a mechanical element that operates in a fashion substantially similar to the switch for selectively providing power to the motor. However, it is also contemplated that reset 72 can be any device suitable for resetting the shut off 70, for example, a mechanical switch. Rather than causing blender 10 to shut off after a time period, shut off 70 can cause shut down after a certain motor temperature is reached. In embodiments such as this, shut off 70 would further include a thermostat suitable for causing motor 50 to shut off upon ascertaining a certain temperature.

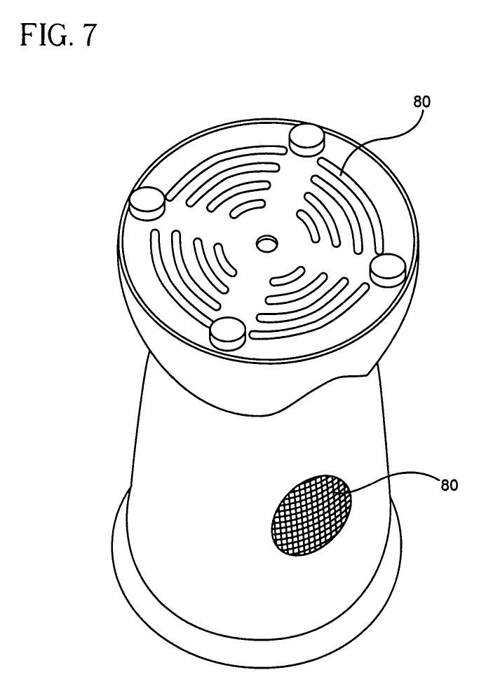

Other embodiments, best shown in FIG. 7, of the present invention include a blender base 12 having a large vent opening 80 on its side for providing better airflow into and out of base 12. Preferably, vent opening 80 is a series of holes extending through the walls of blender base 12. This design allows heat created therein to transfer through the apertures in blender base 12. It is contemplated that blender base 12 may also include more than one vent opening 80, located at any position on base 12, including at lower end 18 on the bottom of body base 22 (best shown in FIG. 7). Furthermore, it is also contemplated that in certain embodiments blender 10 of the present invention may include at least one fan 82 (shown in FIG. 3) within blender base 12. Fan 82 may work in conjunction and may be located adjacent vent opening 80 for providing better airflow and heat transfer out of blender base 12. In preferred embodiments, fan 82 is also located adjacent motor 50 for providing optimum heat transfer out of base 12. Finally, it is contemplated that more than one fan 82 can be situated within blender base 12.

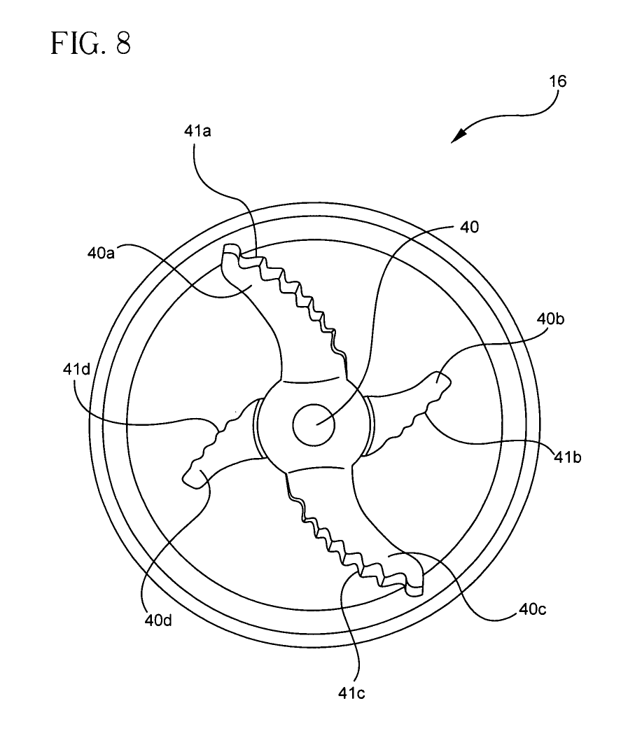

Certain embodiments of blender 10 may also include a blade assembly 40 including at least one blade, having a serrated or scalloped edge. As shown in FIG. 8, an embodiment of the present invention includes a blade 40 having four blades 40a, 40b, 40c, and 40d. Blades 40a, 40b, 40c, and 40d include serrated edges 41a, 41b, 41c, and 41d respectively. Each of the serrated edges is located on a corresponding side of the blades, so that rotation of blade assembly 40 causes the serrated edges to rotate in the same direction (i.e.—as the leading edge). In operation, serrated edges 41a, 41b, 41c, and 41d allow for each blade 40a, 40b, 40c, and 40d of blade assembly 40 to more easily cut through materials located in container 14. In turn, this causes less of a strain on motor 50, and axiomatically less creation of heat.

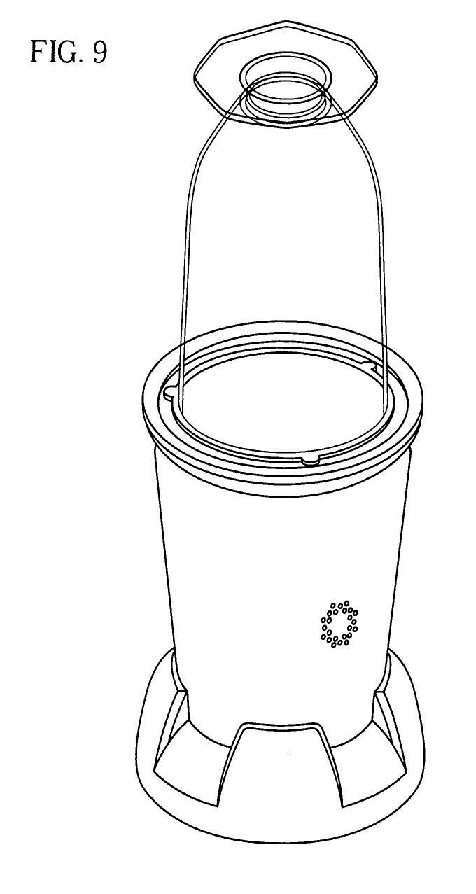

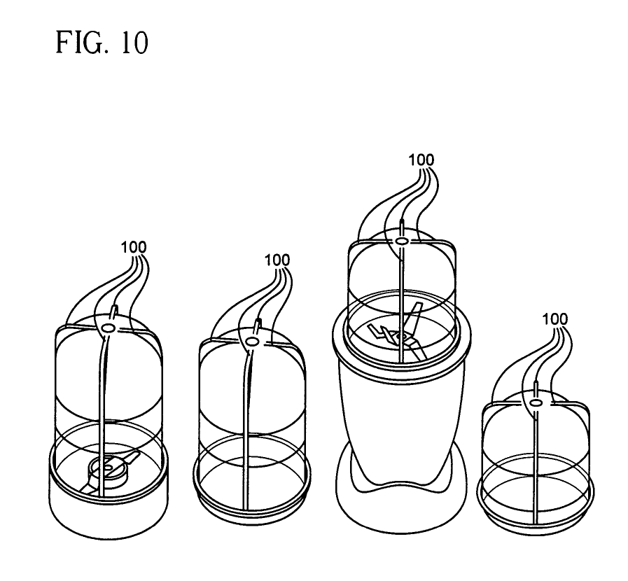

Other embodiments of the present invention are shown in FIGS. 9-10. It is contemplated that the present invention can be shaped in similar fashions to those shown in these Figures. Most notably, container 14 may or may not include stem 32 or rest 34. In other embodiments, as shown best in FIG. 10, ribs 100 can be provided in container 14 that allow the container to rest upright. Similarly, it is contemplated that blender 10 may include a plurality of different sized containers 14 and blender bases 16 having different amounts and shaped blades.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A blender comprising:
a blender body including a motor coupled to a drive shaft;
an electronic circuit providing for shut down of the motor after predetermined time to prevent overheating of the motor;
a container having an interior and one open end;
a blade base including at least one blade, a first end of said blade base adapted to be coupled to the drive shaft, and a second end of said blade base adapted to be attached to the open end of said container, wherein rotation of the drive shaft causes rotation of the at least one blade and attachment of said blade base substantially seals the interior of said container; and
a cap adapted to be attached to the open end of said container.

2. The blender according to claim 1, further comprising a mechanical reset for allowing the motor to be restarted.

3. The blender according to claim 1, wherein said container further includes a threaded portion for facilitating attachment of said blade base and said cap.

4. The blender according to claim 3, wherein said blade base and said cap further include threaded portions.

5. The bender according to claim 1, wherein said blade base includes four blades.

6. The blender according to claim 5, wherein at least one of the four blades is serrated.

7. The blender according to claim 1, wherein said cap includes at least one opening.

8. The blender according to claim 7, wherein said cap includes a plurality of openings.

9. The blender according to claim 1, wherein the period of time after which the motor shuts down is any period within the range of 1 second to 180 seconds.

10. A method of blending a mixture comprising:
providing a blender including a container, blade base, and blender body;
placing ingredients in the container;
attaching the blade base to the container;
inverting the blade base and container;
placing the blade base on the blender body;
operating the blender body to mix the ingredients in the container;
removing the blade base and container from the blender body;
inverting the blade base and container; and
removing the blade base from the container,
wherein the step of operating the blender body to mix the ingredients in the container includes operating a motor, the motor being designed to shut down after a period of time to prevent overheating of the motor.

11. The method according claim 10, further including the step of attaching a cap to the container.

12. The method according to claim 10, wherein the step of attaching the blade base to the container includes screwing the blade base onto the container.

13. The method according to claim 10, further including the step of operating a mechanical reset for restarting the motor.

14. A blender comprising:
a blender body including a motor coupled to a drive shaft;
a container having an interior and one open end;
a blade base including at least one serrated blade, a first end of said blade base adapted to be coupled to the drive shaft, and a second end of said blade base adapted to be attached to the open end of said container, wherein rotation of the drive shaft causes rotation of the at least one blade and wherein attachment of said blade base substantially seals the interior of said container; and
a cap adapted to be attached to the open end of said container.

15. The blender according to claim 14, further comprising an electronic circuit providing for shut down of the motor after predetermined time.

16. The blender according to claim 15, further comprising a mechanical reset for allowing the motor to be restarted.

17. The blender according to claim 15, wherein the period of time after which the motor shuts down is any period within the range of 1 second to 180 seconds.

18. The blender according to claim 14, wherein said container further includes a threaded portion for facilitating attachment of said blade base and said cap.

19. The blender according to claim 18, wherein said blade base and said cap further include threaded portions.

20. The bender according to claim 14, wherein said blade base includes four blades.

21. The blender according to claim 14, wherein said cap includes at least one-opening.

22. The blender according to claim 21, wherein said cap includes a plurality of openings.
